(19) United States
(12) Patent Application Publication
(10) Pub. No.: US 2010/0207523 A1
(43) Pub. Date: Aug. 19, 2010

(54) HALOGEN INCANDESCENT LAMP AND METHOD FOR MANUFACTURING SUCH A LAMP

(75) Inventors: Wilfried Kohlmann, Aldenhoven (DE); Johannes Andreas Zaat, Heerlen (NL); Markus Kornelius Gollan, Aachen (DE); Clyde Liu, Shanghai (CN); Joseph Fey, Maastricht (NL); Gilles Greuillet, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., Eindhoven (NL)

(21) Appl. No.: 11/993,241

(22) PCT Filed: Jun. 23, 2006
(86) PCT No.: PCT/IB06/52037

§ 371 Date: Apr. 26, 2010

(30) Foreign Application Priority Data
Jun. 24, 2005 (CN) 200510079114.0

(51) Int. Cl. H01K 1/50; H01J 9/00

(52) U.S. Cl. 313/579; 445/43

(57) ABSTRACT

A halogen incandescent lamp for operating on line voltage, comprising a sealed bulb made from a transparent material and having a pinch at one end, a filling made from an inert gas and a halogen additive, and a luminous element comprised of a filament, wherein both ends of said filament are each connected with a contact element extending through the pinch, wherein a support structure is mounted in the lamp and extends in the bulb holding the filament in a predetermined shape, wherein the support structure comprises at least one metal support wire having an end part for engaging the filament, and wherein the support structure comprises an insulating glass mount, wherein said support wire is embedded in said glass mount such that no part of said metal support wire, or parts electrically connected therewith other than the contact elements, extend outside the lamp.

### FIELD OF THE INVENTION

The invention relates to a halogen incandescent lamp for operating on line voltage, comprising a sealed bulb made from a transparent material and having a pinch at one end, a filling made from an inert gas and a halogen additive, and a luminous element comprised of a filament, wherein both ends of said filament are each connected with a contact element extending through the pinch, wherein a support structure is mounted in the lamp and extends in the bulb holding the filament in a predetermined shape, wherein the support structure comprises at least one metal support wire having an end part for engaging the filament.

### BACKGROUND OF THE INVENTION

Such a lamp is disclosed in U.S. Pat. No. 6,803,721, which is incorporated herein by reference. The lamp described therein can be produced in a simple and cost-effective manner, because the principle parts, i.e. in particular the lamp bulb and the metal parts to be assembled, in particular the mount and the luminous element, can be prefabricated independently of one another and subsequently connected to one another in a functionally proper and simple way, in particular in conjunction with the manufacture of the pinch. The lamp can be used in all customary main voltages, by which a range of approximately 80 V up to 250 V is to be understood, and various power consumptions in the private as well as the professional sphere.

A danger of main voltage halogen lamps is that under the high voltages as applied, there can occur several dangerous situations, such as electric shock, shunt and/or explosion of the lamp. The known lamp has two molybdenum foils attached between the ends of the luminous element and the contact elements, said molybdenum foils being embedded in the pinch. Such large molybdenum foils can prolong arcing, which can occur in the lamp in particular near the end-of-life of the lamp. In order to prevent said arcing and a possible explosion of the lamp, the support construction of the known lamp is attached to a third molybdenum foil, which is embedded in the pinch between the other two molybdenum foils. This construction has the disadvantage that there is a third electrical connection to the outer side of the bulb.

### OBJECT AND SUMMARY OF THE INVENTION

It is an object of the invention to provide a safer lamp.

According to a first aspect of the invention the support structure comprises an insulating glass mount, wherein said support wire is embedded in said glass mount such that no part of said metal support wire, or parts electrically connected therewith other than the contact elements, extend outside the bulb. Usually quartz glass is used in the lamps.

According to an alternative aspect of the invention at least one end of the filament is connected to one of said contact elements through a fuse wire extending in the bulb. Also both ends of the filament can be connected to their respective contact elements by fuse wires. It is known to use external fuse wires for lamps. By using an internal fuse wire the lamp is intrinsically safer.

According to a first preferred embodiment said glass mount is fitted in the bulb. Preferably the wall of the bulb is dimpled on two opposite sides in order to engage the glass mount. Preferably one of the support wires extends through the glass mount such that an engaging portion is present at the bottom side for positioning purposes during manufacturing.

According to a second preferred embodiment said glass mount is fitted in the pinch. In the latter case the glass mount substitutes the middle molybdenum foil of the known lamp. This glass mount has to be made of quartz or a glass with nearly the same expansion coefficient as the pinch.

In a further preferred embodiment the ends of the filament are connected to lead-in wires extending through the glass mount. Said lead-in wires fix the ends of the filament in place.

In a further preferred embodiment said glass mount is fitted on a mount wire, which mount wire is electrically isolated from the support wire by means of said glass mount, which mount wire is fitted in the pinch.

In a further preferred embodiment said glass mount extending in the bulb holds more than one metal support wire. Thereby complex shapes of the filament can be realised.

In a further preferred embodiment said mount wire is embedded in a second glass mount, and said second glass mount is fitted in the pinch, such that no part of said mount wire, or parts electrically connected therewith, extend outside the lamp.

Preferably said first or second glass mount being fitted in the pinch is a glass strip, said support wire or mount wire being attached to one end of said strip. Preferably an engaging wire is attached to the other end of said glass strip such that an engaging portion is present at the bottom side for positioning purposes during manufacturing.

Preferably said filament is connected to the contact elements through molybdenum foils extending in the pinch.

The invention also relates to a method for manufacturing a halogen incandescent lamp for operating on line voltage, comprising the steps of producing a bulb from a transparent material and having an open end, producing a luminous element comprised of a filament, connecting both ends of said filament with a contact element, attaching the filament to a support structure in a predetermined shape, which support structure comprises at least one metal support wire having an end part for engaging the filament, mounting the support structure in the lamp, closing the open end of the bulb through a pinch while engaging said contact elements, filling the bulb with an inert gas and a halogen additive through an opening in the bulb and sealing the bulb.

### BRIEF DESCRIPTION OF THE INVENTION

These and other aspects of the invention will be apparent from and elucidated with reference to the following exemplary embodiments as shown in the drawings. Similar elements in different embodiments are assigned the same reference numerals.

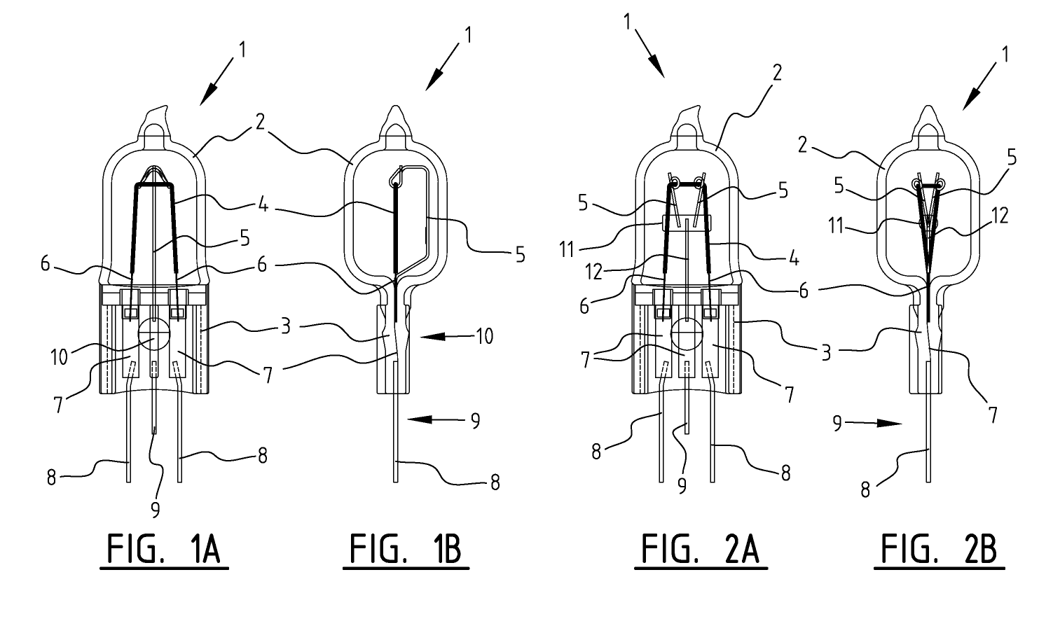

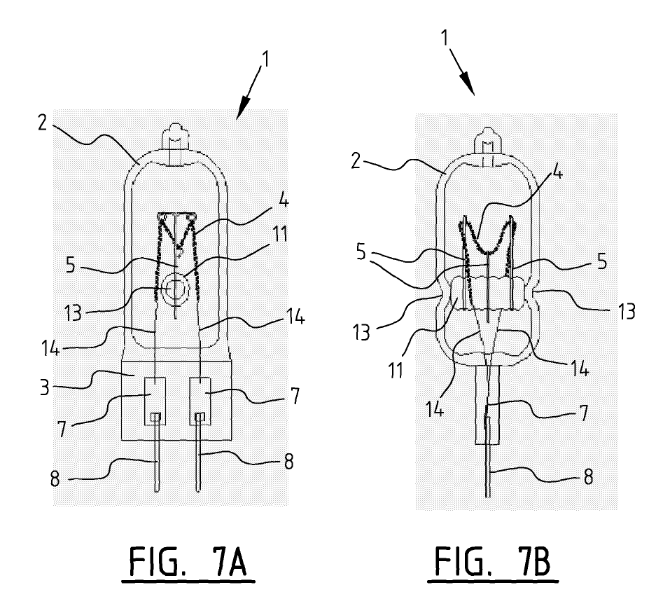

In the drawings FIG. 1A/B-FIG. 7A/B show perpendicular cross sections of respective halogen incandescent lamps.

With reference to the Figures, halogen incandescent lamps 1 for general lighting purposes are described, which are suitable for direct connection to a 220 V mains. The halogen incandescent lamp 1 has a substantially cylindrical bulb 2 made from quartz glass with an outside diameter of 12.75 mm and an overall length of approximately 45 mm. The inner space of the bulb 2 is filled in a known way with an inert gas mixture, which is known per se, often containing a conventional halogen additive.

The end of the bulb 2 remote from the pinch bears a dome, which has what is termed an exhaust tip in the centre. The other end of the bulb 2 is hermetically sealed with a pinch 3. The substantially parallel outer surfaces of the single pinch 3, which are produced by the direct action of the pinching tool, are arranged in the centre and symmetrically relative to the lamp axis. The luminous element 4 has a luminous and continuously coiled section in its central portion, made of a material customary for halogen lamps. The two ends of the single-piece luminous element 4 simultaneously serve for power supply. These ends are connected with a sealing foil 7 and a contact pin 8. The two contact pins 8 are connected with electrical conduction to the respective sealing foils 7. They are partly embedded in the pinch 3 and partly project from the pinch 3.

### DETAILED DESCRIPTION OF THE INVENTION

According to the embodiments in FIGS. 1A/B-4A/B, the two ends of luminous element 4 each have a singly coiled section forming supply leads 6, which are partly sealed into the pinch and which are connected with electrical conduction to sealing foils 7 embedded in the pinch 3. The two supply leads 6 are arranged substantially parallel to one another in the pinch 3.

A plane in which the two ends of the luminous element 4 and one end of the support wire 5 are located is present centrally in the interior of the pinch 3 so as to be parallel thereto. The two limbs of the luminous element 4 bent into the shape of a U, located in or near the extension of the above-named plane, and arranged symmetrically relative to the lamp axis, widen slightly in a direction toward the pinch 3.

According to the embodiment in FIGS. 1A/B the support wire 5 in the top portion, which is arranged transverse to the lamp axis, holds the luminous element 4 twice. The support wire 5, which comprises a coiled and bent support wire and a material customary for halogen lamps, is attached to a strip shaped glass mount 10, which is sealed and fixed in the pinch 3, substantially axially parallel between the two parts of the power supply system. An engaging wire 9 is attached to the other end of the glass mount 10. The parts of the power supply system are, in particular, the two supply leads 6, the sealing foils 7, and the pin contacts 8. As may be seen in FIG. 1B, the bending line of the support wire lies in a plane, which is at right angles to the plane in which the limbs of the luminous element 4 are arranged. At its other end, in the region of the two support points, the support wire 5 is designed as a projecting hook whose opening faces the end of the bulb 2 remote from the pinch 3.

According to FIGS. 2A/B the support structure comprises the engaging wire 9, which is attached to one end of a sealing Mo-foil 7, said sealing foil 7 being sealed and fixed in the pinch 3, substantially axially parallel between the two part of the power supply system. To the other end of said sealing foil 7 is attached a mount wire 12, on top of which a beam shaped glass mount 11 is mounted, said mount 11 holding two support wires 5. The support wires 5 and the mount wire 12 are electrically isolated from each other by the glass mount 11. The support wires 5 each are slanting towards a different direction, seen in both cross sections, such that the substantially U-shaped luminous element is slightly rotated out of the aforementioned plane.

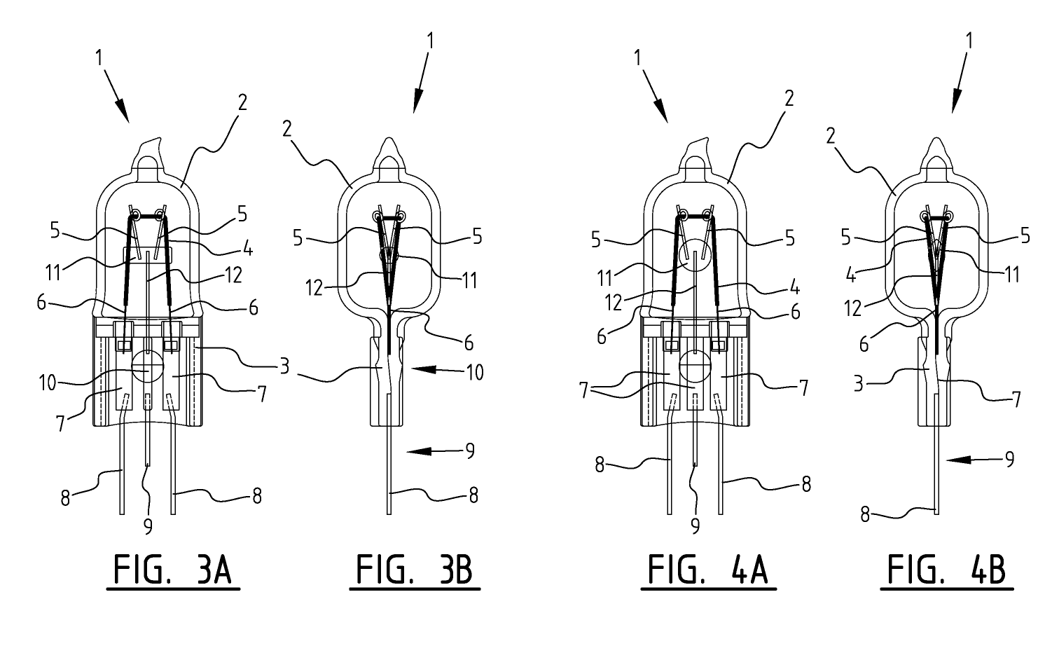

As shown in FIGS. 3A/B the strip shaped glass mount 10 in the pinch 3 and the beam shaped glass mount 11 extending in the bulb 2 can also be combined in one lamp.

As shown in FIGS. 4A/B the glass mount 11 can have different shapes, in this case a disc shape.

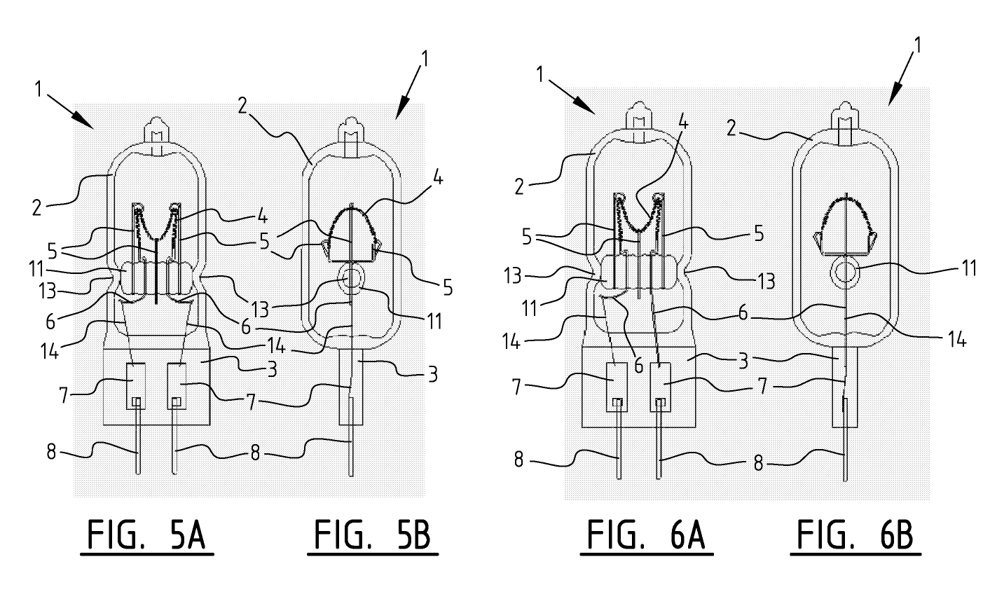

According to FIGS. 5A/B-7A/B the beam shaped glass mount 11, while holding the support wires 5, is engaged by two dimples 13 in opposite sides of the cylindrical wall of the glass bulb 2. Also shown is that, by using several support wires 5, a complex shaped luminous element 4 can be formed, such as a three-dimensionally arced and/or W-shaped element 4.

According to FIGS. 5A/B the supply leads 6 extend trough the glass mount 11, and are connected to two fuse wires 14, said fuse wires 14 being connected to the foils 7.

As shown in FIGS. 6A/B also one fuse wire 14 can be applied and connected between one of the supply leads 6 and one of the sealing foils 7, where the other supply lead 6 is directly connected to one of the sealing foils 7.

As shown in FIGS. 7 A/B the fuse wires 14 can also be connected directly to the ends of the luminous element 4, and extend aside the glass mount 11.

The inner part of the halogen incandescent lamp 1, including the support structure comprising the engaging wire 9, the glass strip 10, the mount wire 12, the glass mount 11, and the support wires 5 in as far as present in the above embodiments, as well as the luminous element 4, the supply leads 6, the sealing foils 7, and the pin contacts 8, form a mechanically stable semi-finished product which was manufactured in one or more mounting steps before the final assembly of the halogen incandescent lamp 1, i.e. in particular the joining together of the glass bulb 2 and the inner parts.

1. A halogen incandescent lamp (1) for operating on line voltage, comprising a sealed bulb (2) made from a transparent material and having a pinch (3) at one end, a filling made from an inert gas and a halogen additive, and a luminous element comprised of a filament (4), wherein both ends of said filament (4) are each connected with a contact element (8) extending through the pinch (8), wherein a support structure is mounted in the lamp (1) and extends in the bulb (2) holding the filament (4) in a predetermined shape, wherein the support structure comprises at least one metal support wire (5) having an end part for engaging the filament (4), characterized in that the support structure comprises an insulating glass mount (10; 11), wherein said support wire (5) is embedded in said glass mount (10; 11) such that no part of said metal support wire (5), or parts electrically connected therewith other than the contact elements (8), extend outside the bulb (2).

2. The lamp (1) as claimed in claim 1, wherein at least one end of the filament (4) is connected to one of said contact elements (8) through a fuse wire (14) extending in the bulb (2).

3. The lamp (1) as claimed in claim 1, wherein said glass mount (11) extends entirely in the bulb (2).

4. The lamp (1) as claimed in claim 3, wherein the wall of the bulb (2) is dimpled on two opposite sides in order to engage the glass mount (11).

5. The lamp (1) as claimed in claim 3, wherein said glass mount (11) is fitted on a mount wire (12), which mount wire (12) is electrically isolated from the support wire (5) by means of said glass mount (11), which mount wire (12) is fitted in the pinch (3).

6. The lamp (1) according to claim 5, wherein said mount wire (12) is embedded in a second glass mount (10), and said second glass mount (10) is fitted in the pinch (3), such that no part of said mount wire (12), or parts electrically connected therewith, extend outside the bulb (2).

7. The lamp (1) as claimed in claim 3, wherein the ends of the filament (4) are connected to lead-in wires (6) extending through the glass mount (11) extending in the bulb (2).

8. The lamp (1) according to claim 3, wherein said glass mount (11) extending in the bulb holds more than one metal support wire (5).

9. The lamp (1) as claimed in claim 1, wherein said glass mount (10) holding the support wire (5) is fitted in the pinch.

10. The lamp (1) as claimed in claim 9, wherein the glass mount (10) being fitted in the pinch (3) is a glass strip, said support wire (5) or mount wire (12) being attached to one end of said strip.

11. The lamp (1) as claimed in claim 10, wherein an engaging wire (9) is attached to the other end of said glass strip.

12. The lamp (1) as claimed in claim 1, wherein said filament (4) is connected to the contact elements (8) through Molybdenum foils (7) extending in the pinch (3).

13. A halogen incandescent lamp (1) for operating on line voltage, comprising a sealed bulb (2) made from a transparent material and having a pinch (3) at one end, a filling made from an inert gas and a halogen additive, and a luminous element comprised of a filament (4), wherein both ends of said filament (4) are each connected with a contact element (8) extending through the pinch (3), wherein a support structure is mounted in the lamp (1) and extends in the bulb (2) holding the filament (4) in a predetermined shape, wherein the support structure comprises at least one metal support wire (5) having an end part for engaging the filament (4), characterized in that at least one end of the filament (4) is connected to one of said contact elements (8) through a fuse wire (14) extending in the bulb (2).

14. A method for manufacturing a halogen incandescent lamp (1) for operating on line voltage, comprising the steps of producing a bulb (2) from a transparent material and having an open end, producing a luminous element comprised of a filament (4), connecting both ends of said filament (4) with a contact element (8), attaching the filament (4) to a support structure in a predetermined shape, which support structure comprises at least one metal support wire (5) having an end part for engaging the filament (4), mounting the support structure in the lamp (1), closing the open end of the bulb (2) through a pinch (3) while engaging said contact elements (8), filling the bulb (2) with an inert gas and a halogen additive through an opening in the bulb (2) and sealing the bulb (2), characterized in that the support structure comprises an insulating glass mount (10; 11), and said support wire (5) is embedded in said glass mount (10; 11) such that no part of said metal support wire (5), or parts electrically connected therewith other than the contact elements (8), extend outside the bulb (2).
